(19) United States
(12) Patent Application Publication
(10) Pub. No.: US 2025/0367903 A1
(43) Pub. Date: Dec. 4, 2025

(54) COMPOSITE SHEET AND METHOD OF MAKING THEREOF

(71) Applicant: SHENZHEN LINGYI INNOVATION TECHNOLOGY CO., LTD., Shenzhen (CN)

(72) Inventor: Yanghui ZHENG, Shenzhen (CN)

(21) Appl. No.: 18/223,000

(22) PCT Filed: Jun. 13, 2023
(86) PCT No.: PCT/CN2023/099881

§ 371 Date: Jul. 17, 2023

(30) Foreign Application Priority Data
Feb. 24, 2023 (CN) 202320412209.3

(51) Int. Cl. B32B 5/02; B32B 5/08; B32B 5/12; B32B 5/26; B32B 7/022; B32B 7/12; B32B 37/06; B32B 37/10

(52) U.S. Cl. CPC B32B 5/024; B32B 5/08; B32B 5/12; B32B 5/263; B32B 7/022; B32B 7/12; B32B 37/06; B32B 37/10; B32B 2250/20; B32B 2262/0269; B32B 2262/101; B32B 2262/106; B32B 2262/148; B32B 2305/08; B32B 2305/188; B32B 2307/516; B32B 2307/518; B32B 2307/558; B32B 2307/7376; B32B 2309/02; B32B 2309/04; B32B 2309/12; B32B 2437/00

(57) ABSTRACT

A composite sheet is provided. The composite sheet includes one or more outer fiber reinforcement layers and one or more intermediate structural support layers. At least one surface of the composite sheet is an outer fiber reinforcement layer of the one or more outer fiber reinforcement layers. The one or more outer fiber reinforcement layers include at least one of an aramid fiber cloth layer, an aramid carbon fiber blend layer, an aramid glass fiber blend layer, and a natural plant fiber layer. The one or more intermediate structural support layers include at least one of a carbon fiber cloth layer and a carbon glass fiber blend layer. The composite sheet may be used to make watch straps.

### TECHNICAL FIELD

The present disclosure generally relates to composite materials and, more particularly, to a composite sheet and the method of making it.

### BACKGROUND

With the reduction in the cost of manufacturing technology and process, materials originally used in the military and aerospace sectors, such as carbon fibers and aramid fibers, are slowly becoming popular in the private sector due to the excellent properties of the materials. The field of high-end wearable devices first began to adopt carbon fiber materials. The watch straps made from carbon fiber sheets are characterized by their light weight and high strength. However, carbon fiber has many disadvantages. First, carbon fiber has only one color and can only be used with a simple weave, which cannot meet the requirements for the weave of color patterns. Second, from a safety point of view, when a carbon fiber watch strap collides with a hard object when it is worn by a user, its lack of pressure resistance may cause the surface to break or even produce carbon fiber debris, which may cause injury to the user's skin. Third, compared to stainless steel straps, carbon fiber watch straps are less able to withstand lateral stretching during use thus prone to break, affecting the user experience.

The above content is only used to assist in understanding the technical solutions of the present application, and does not constitute an admission that the above is prior art.

### SUMMARY

There is a need for improved materials that improve upon, and help to address the shortcomings of conventional materials, such as those described above. In particular, there is a need for a composite sheet with better performance.

In order to overcome the drawback mentioned above, the present disclosure provides a composite sheet and the method of making it.

To achieve the above objectives, some exemplary embodiments of the present disclosure provide a composite sheet. The composite sheet may include one or more outer fiber reinforcement layers and one or more intermediate structural support layers. In some embodiments, the color of the one or more outer fiber reinforcement layers can be dyed or is different from the color of the one or more intermediate structural support layers. In some embodiments, at least one surface of the composite sheet may be a first outer fiber reinforcement layer of the one or more outer fiber reinforcement layers. In some embodiments, the toughness of the one or more outer fiber reinforcement layers is higher than 2.6 MPa·m^{1/2}. In some embodiments, the toughness of the one or more outer fiber reinforcement layers is higher than the toughness of the one or more intermediate structural support layer. In some embodiments, the toughness of the one or more outer fiber reinforcement layers is higher than two times of the toughness of the one or more intermediate structural support layer. In some embodiments, another surface of the composite sheet may be a second outer fiber reinforcement layer of the one or more outer fiber reinforcement layers.

In some embodiments, the one or more outer fiber reinforcement layers may include at least one of an aramid fiber cloth layer, an aramid carbon fiber blend layer, an aramid glass fiber blend layer, and a natural plant layer. In some embodiments, the thickness of the aramid fiber cloth layer may be 0.1-0.3 mm. In some embodiments, the one or more intermediate structural support layers may include at least one of a carbon fiber cloth layer and a carbon glass fiber blend layer. In some embodiments, the carbon fiber cloth layer may include recycled carbon fiber materials.

In some embodiments, two adjacent layers may be glued together by a thermoplastic resins coating or a thermosetting resins coating. In some embodiments, the first outer fiber reinforcement layer may be a bi-directional woven outer fiber reinforcement layer. In some embodiments, a second outer fiber reinforcement layer of the one or more outer fiber reinforcement layers may be a unidirectional woven outer fiber reinforcement layer. In some embodiments, the one or more intermediate structural support layers are unidirectional woven intermediate structural support layers.

In some embodiments, except for the first outer fiber reinforcement layer, all other layers are stacked in such a way that first weaving directions of each pair of adjacent layers differ by no less than 0° and no greater than 180°. In some embodiments, the first weaving directions of each pair of adjacent layers differ by 45°.

In some embodiments, isotropic stacking is used on a set of layers that are to be cut. In some embodiments, bi-directional woven fabrics are used on a set of layers that are to be cut.

In some embodiments, a process of making the composite sheet may obtain pre-impregnated aramid fiber clothes and pre-impregnated carbon fiber clothes. The process may stack and glue the pre-impregnated aramid fiber clothes and the pre-impregnated carbon fiber clothes to obtain a semi-finished product. The process may rapidly increase the temperature of a press machine to a first temperature while the semi-finished product is placed in the press machine. The process may slowly and synchronously increase the pressure of the press machine to a pressure level to extrude the semi-finished product. The process may maintain the pressure level and the first temperature for a first time period. The process may reduce the temperature of the press machine to a second temperature within a second time period. The process may maintain the pressure level and the second temperature for a third time period.

In some embodiments, the first temperature may be in the range of 100-200 degrees Celsius. In some embodiments, the pressure level may be in the range of 700-1200 Kg. In some embodiments, the first time period may be in the range of 4-8 hours. In some embodiments, the second temperature may be room temperature. In some embodiments, the second time period may be in the range of 3-15 minutes. In some embodiments, the third time period may be in the range of 1-3 hours.

In some embodiments, a section of a watch strap is provided. The section of the watch strap may include one or more outer fiber reinforcement layers and one or more intermediate structural support layers. In some embodiments, the color of the one or more outer fiber reinforcement layers can be dyed or is different from the color of the one or more intermediate structural support layers. In some embodiments, at least one surface of the section of the watch strap may be a first outer fiber reinforcement layer of the one or more outer fiber reinforcement layers. In some embodiments, the toughness of the one or more outer fiber reinforcement layers is higher than the toughness of the one or more intermediate structural support layer. In some embodiments, the toughness of the one or more outer fiber reinforcement layers is higher than two times of the toughness of the one or more intermediate structural support layer.

In some embodiments, the first outer fiber reinforcement layer may be an aramid fiber cloth layer. In some embodiments, the aramid fiber cloth layer may be a bi-directional woven fabric. In some embodiments, the one or more intermediate structural support layers are unidirectional woven intermediate structural support layers.

Note that the various embodiments described above can be combined with any other embodiments described herein. The features and advantages described in the disclosure are not all inclusive and, in particular, many additional features and advantages will be apparent to one of ordinary skill in the art in view of the drawings, specification, and claims. Moreover, it should be noted that the language used in the disclosure has been principally selected for readability and instructional purposes, and may not have been selected to delineate or circumscribe the inventive subject matter.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1 illustrates an example of the structure of a composite sheet according to some embodiments of the present disclosure.

FIG. 2 illustrates an example of the stacked structure of a composite sheet according to some embodiments of the present disclosure.

FIG. 3 is a cross sectional view of a wave-like microstructure of a composite sheet according to some embodiments of the present disclosure.

FIG. 4 illustrates an example of a process for obtaining pre-impregnated fiber clothes that may be used to make composite sheets according to some embodiments of the present disclosure.

FIG. 5 illustrates an example of a process for obtaining a composite sheet according to some embodiments of the present disclosure.

FIG. 6 illustrates an implementation example of the composite sheet according to some embodiments of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

As discussed above, to resolve the problem in the related technologies, in some embodiments, a composite sheet is provided. The composite sheet can have a variety of colors, thus is able to weave complicated patterns for a design. The toughness of the surface layer of a composite sheet is higher than that of the traditional type of sheet. Therefore, when made into a strap, belt, chain, and other products that require a certain amount of tensile strength, the composite sheet can meet the structural strength requirements of these types of products.

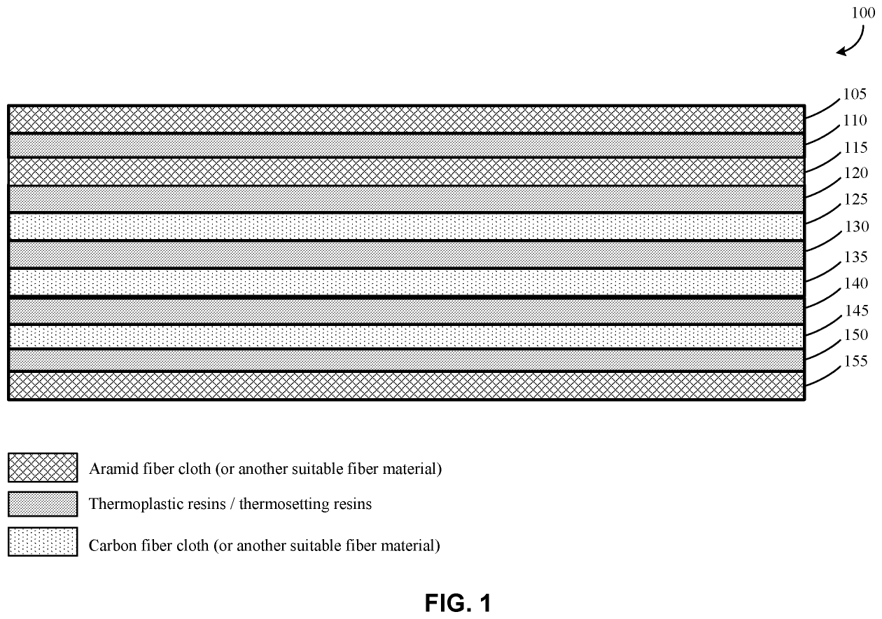

FIG. 1 illustrates an example of the structure of a composite sheet 100 according to some embodiments of the present disclosure. In this example, the composite sheet 100 includes two aramid fiber cloth layers 105 and 115 on the top. The aramid fiber cloth layers 105 and 115 are glued together by a thermoplastic/thermosetting resins coating 110. In some embodiments, it may be preferrable to use the thermoplastic resins coating than the thermosetting resins coating because the thermoplastic resins coating may be recycled and reused while the thermosetting resins coating cannot be recycled.

The composite sheet 100 further includes three carbon fiber cloth layers 125, 135, and 145 below the aramid fiber cloth layers 105 and 115. The aramid fiber cloth layer 115 and the carbon fiber cloth layer 125 are glued together by a thermoplastic/thermosetting resins coating 120. The carbon fiber cloth layers 125 and 135 are glued together by a thermoplastic/thermosetting resins coating 130. The carbon fiber cloth layers 135 and 145 are glued together by a thermoplastic/thermosetting resins coating 140.

The composite sheet 100 further includes an aramid fiber cloth layer 155 at the bottom. The carbon fiber cloth layer 150 and the aramid fiber cloth layer 155 is glued together by a thermoplastic/thermosetting resins coating 150.

As shown in FIG. 1, the composite sheet 100 may include several outer fiber reinforcement layers (e.g., the aramid fiber cloth layers 105, 115, and 155) and several intermediate structural support layers (e.g., the carbon fiber cloth layers 125, 135, and 145). The outer fiber reinforcement layers may be the layers that are at or close to the visible or decorative surface(s) of the composite sheet; and the intermediate structural support layers may be the layers that are away from the visible or decorative surface of the composite sheet.

In some embodiments, an outer fiber reinforcement layer may be an aramid cloth layer, or another fiber material with a higher tenacity than the material for an intermediate structural support layer, or a blend of several fiber materials, e.g., an aramid carbon fiber blend layer, an aramid glass fiber blend layer. In some embodiments, an outer fiber reinforcement layer may be a natural plant fiber layer. In some embodiments, an outer fiber reinforcement layer may be either on one side of the intermediate structural support layer(s) or on both sides. In some embodiments, the toughness of the one or more outer fiber reinforcement layers is higher than 2.6 MPa·m^{1/2}. In some embodiments, the toughness of the one or more outer fiber reinforcement layers is higher than the toughness of the one or more intermediate structural support layers. In some embodiments, the toughness of the one or more outer fiber reinforcement layers is higher than two times of the toughness of the one or more intermediate structural support layer. In some embodiments, the color of the one or more outer fiber reinforcement layers can be dyed or is different from the color of the one or more intermediate structural support layers.

In some embodiments, the outer fiber reinforcement layer of aramid fiber cloth may have more than one layer. In some embodiments, the thickness of a single layer of aramid fiber cloth may be around 0.1-0.3 mm (depending on the denier number of the aramid fibers). The aramid fiber cloth layer may be used as a decorative outer layer of the laminate, providing a colorful pattern as well as a wrapping effect.

In some embodiments, an intermediate structural support layer may be a carbon fiber cloth layer, or another fiber material with a certain degree of rigidity, e.g., a carbon glass fiber blend layer.

In some embodiments, the intermediate structural support layer may contain recycled materials. In some embodiments, the carbon fiber cloth layer contains recycled carbon fiber materials. The tensile resistance of the recycled carbon fiber materials is relatively low due to short fiber lengths. By adopting the anisotropic stacking method of the present disclosure, the tensile resistance of the recycled materials may be improved.

In some embodiments, the number of intermedia structural support layers of carbon fiber is two or more. As the main part of the composite sheet, the intermedia structural support layers of carbon fibers provide a certain structural support strength and thickness.

The combination of one or more outer fiber reinforcement layers and one or more intermediate structural support layers brings about several beneficial effects. For example, such a combination solves the problem of the single color of the conventional carbon fiber sheet, improves the color variety of the sheet, and allows arbitrary patterns (i.e., pixel-based patterns) to be obtained by means of weaving. For another example, the combination of one or more outer fiber reinforcement layers and one or more intermediate structural support layers improves the surface toughness of the sheet, thus solves the problem of poor surface toughness of the conventional carbon fiber sheets. For yet another example, due to the compounding of multiple materials and the stacking of the layers, the molecular friction between the layers is increased, thus achieving an improved tensile strength compared to the single fiber cloth material.

As a man-made fiber material, whether it is aramid or carbon fiber, it must first be woven into cloth before it can be used. The basic weaving forms include bi-directional and unidirectional woven fabrics. Bi-directional fiber cloth is made using fiber strands, woven in both warp and weft, which avoids the disadvantage of unidirectional cloth being subjected to forces in only one direction. A unidirectional fabric is one in which the two strands have a large number of filaments in one weaving direction (usually the warp direction) and only a few, usually thin, filaments in the other weaving direction, so that practically all the strength of the fabric is in the first weaving direction. Generally speaking, bi-directional woven fabrics are characterized by selectable weaving patterns, lighter, thinner, softer, and uniform strength in all weaving directions but are expensive to make. Unidirectional woven fabrics are characterized by high strength in the first weaving direction (but weak in the second weaving direction), not resistant to wear and tear and are prone to ageing, easy to be produced in large quantity, and relatively inexpensive.

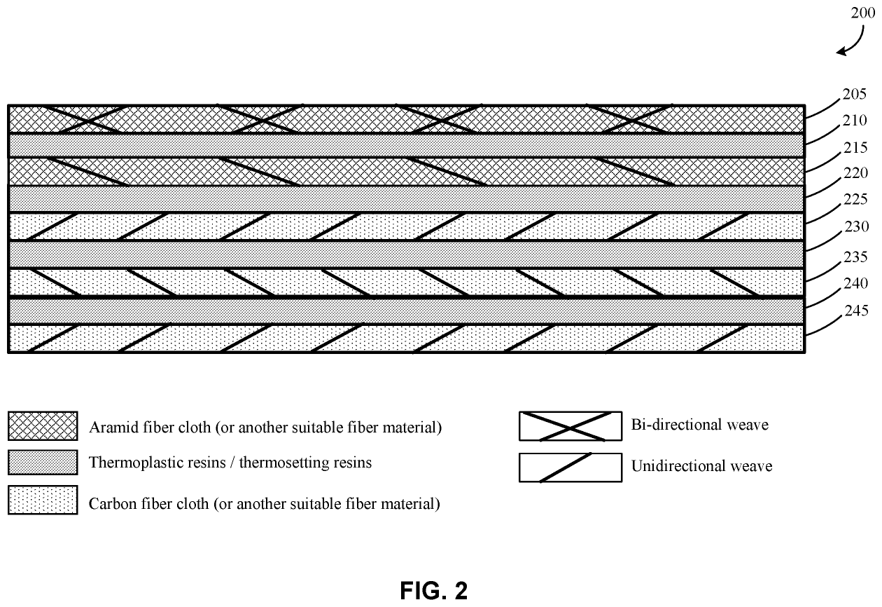

FIG. 2 illustrates an example of the stacked structure of a composite sheet 200 according to some embodiments of the present disclosure. In some embodiments, the composite sheet 200 may be at least a portion of the composite sheet 100 described above with reference to FIG. 1. In this example, the composite sheet 200 includes two aramid fiber cloth layers 205 and 215 on the top. The aramid fiber cloth layers 205 and 215 are glued together by a thermoplastic/thermosetting resins coating 210.

The composite sheet 200 further includes three carbon fiber cloth layers 225, 235, and 245 below the aramid fiber cloth layers 205 and 215. The aramid fiber cloth layer 215 and the carbon fiber cloth layer 225 are glued together by a thermoplastic/thermosetting resins coating 220. The carbon fiber cloth layers 225 and 235 are glued together by a thermoplastic/thermosetting resins coating 230. The carbon fiber cloth layers 235 and 245 are glued together by a thermoplastic/thermosetting resins coating 240.

In some embodiments, the weaving form of the outermost layer (e.g., the aramid fiber cloth layer 205) is preferably a bi-directional weave, as the outer fiber reinforcement layer takes into account color and pattern. In some embodiments, the aramid fiber layer other than the outermost layer (e.g., the aramid fiber cloth layer 215) preferably uses a unidirectional weave. The bi-directional fabric weave process is divided into twill weave process and plain weave process. The patterns produced by twill weave process and plain weave process are different and the specific choice of weave process is determined by the requirements regarding the appearance and pattern of the product.

In some embodiments, a carbon fiber layer (e.g., the carbon fiber cloth layer 225, 235, or 245), as an intermediate structural support layer, may only needs to provide structural strength and does not need to consider appearance and ageing resistance, and is preferably a unidirectional woven fabric.

In some embodiments, except for the outermost layer (e.g., the aramid fiber cloth layer 205), all other layers are stacked in such a way that the first weaving direction of each adjacent layer (or multiple layers) differs by no less than 0° and no greater than 180°. For example, the first weaving direction of layer n (e.g., the aramid fiber cloth layer 215) is 0° and the first weaving direction of layer n+1 (e.g., the carbon fiber cloth layer 225) is 45°,and so on. In another example, the first weaving direction is 0° for levels n and n+1, 90° for level +2, 0° for level n+3 and n+4, and so on. This enables the layers of fiber clothes to be stacked in such a way that, due to the inherent flexibility of the fabric, the microscopic concave and convex structures on the top and bottom surfaces of the layers are embedded in each other, resulting in a wave-like laminate structure. This structure allows for increased friction between the layers, which in turn increases the tensile strength. In some embodiments, better tensile properties between the layers may be obtained with a 45 degree stacking method.

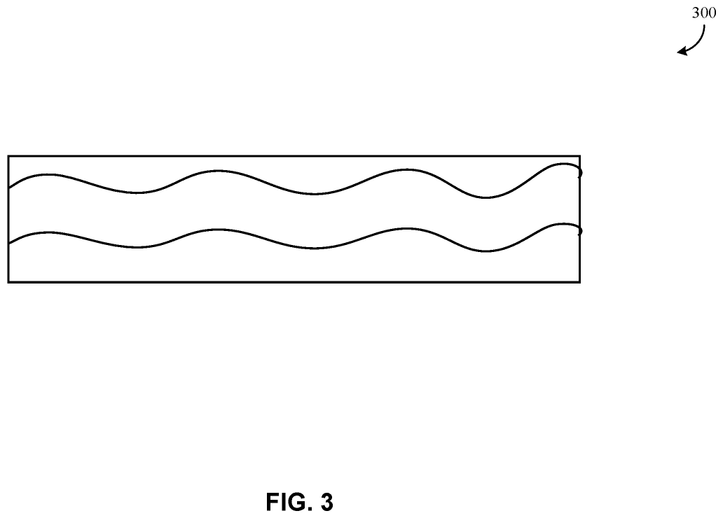

FIG. 3 is a cross sectional view of a wave-like microstructure of a composite sheet 300 according to some embodiments of the present disclosure. In some embodiments, the composite sheet 300 may be at least a portion of the composite sheet 100 or 200 described above with respect to FIG. 1 and FIG. 2. As shown in FIG. 3, the layers of fiber clothes are stacked in such a way that, due to the inherent flexibility of the fabric, the microscopic concave and convex structures on the top and bottom surfaces of the layers are embedded in each other, resulting in a wave-like laminate structure. This structure allows for increased friction between the layers, which in turn increases the tensile strength.

In some embodiments, the stacking angle (i.e., the difference of the first weaving directions between two adjacent layers) may need to be adjusted depending on two things: (1) the distribution of the grain of the fabric so that the layers are better embedded with each other; and (2) whether there is a need for cutting at a particular layer, depending on the product to which the composite sheet corresponds. When anisotropic stacking (i.e., stacked layers with different first weaving directions) is used to obtain a certain type of fiber composite sheet, it can be the case that the side grain of the composite sheet is overly complicated and unattractive when cut. In order to solve the problem of broken grain on the processed side, and in the case of products with particularly high requirements for side grain, it may be necessary to change the stacking angle of the composite sheet. For example, in the pre-defined layers to be cut, the tendency is to choose an isotropic stacking (i.e., stacked layers with the same first weaving direction), thus ensuring that the grain on the processed side is highly consistent and flat when cut. In addition, in some embodiments, bi-directional woven fabrics may be used for stacking without considering the cost, so that the stacking angle may not need to be considered or adjusted.

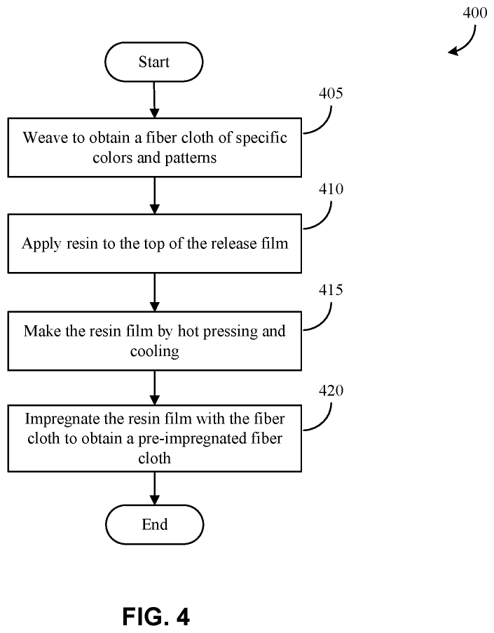

FIG. 4 illustrates an example of a process 400 for obtaining pre-impregnated fiber clothes that may be used to make composite sheets according to some embodiments of the present disclosure. The pre-impregnated fiber clothes obtained through the process 400 may be stacked and pressed to form a composite sheet, which may be the composite sheet 100, 200, or 300 described above with respect to FIGS. 1-3.

At 405, the process may weave to obtain a fiber cloth of specific colors and patterns. In some embodiments, the fiber cloth may be an aramid fiber cloth or a carbon fiber cloth.

At 410, the process may apply resin to the top of the release film. In some embodiments, the resin may be RC40-50 epoxy resin. In some embodiments, the resin may be applied through a gluing machine.

At 415, the process may make the resin film by hot pressing the release firm applied with the resin and cooling it.

At 420, the process may impregnate the resin film with the fiber cloth to obtain a pre-impregnated fiber cloth. In some embodiments, the impregnating may be conducted through a prepreg equipment.

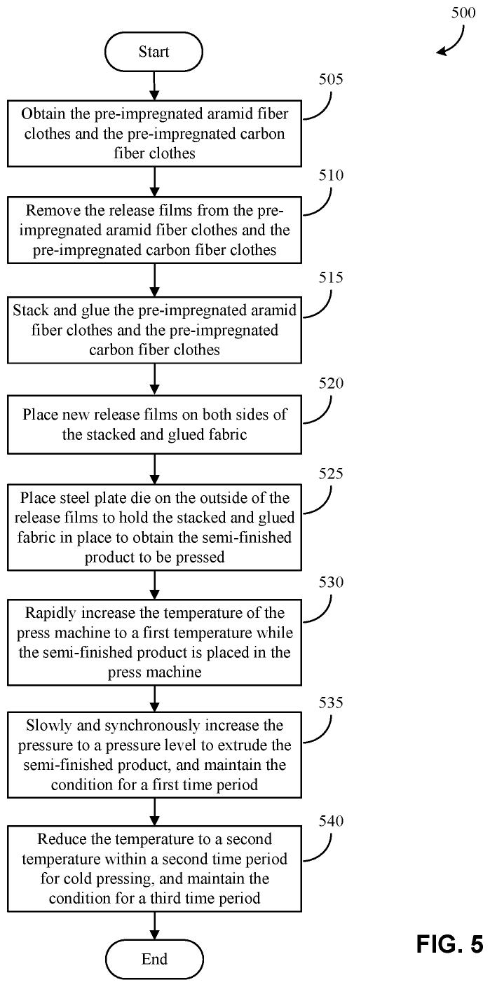

FIG. 5 illustrates an example of a process 500 for obtaining a composite sheet according to some embodiments of the present disclosure. The composite sheet obtained through the process 500 may be the composite sheet 100, 200, or 300 described above with respect to FIGS. 1-3.

At 505, the process may obtain the pre-impregnated aramid fiber clothes and the pre-impregnated carbon fiber clothes. In some embodiments, the pre-impregnated aramid fiber clothes and the pre-impregnated carbon fiber clothes may be obtained through the process 400 described above with reference to FIG. 4.

At 510, the process may remove the release films from the pre-impregnated aramid fiber clothes and the pre-impregnated carbon fiber clothes.

After the release films are removed, the process may stack and glue, at 515, the pre-impregnated aramid fiber clothes and the pre-impregnated carbon fiber clothes. The pre-impregnated aramid fiber clothes and the pre-impregnated carbon fiber clothes may have some adhesion at this point due to the presence of resin. In some embodiments, the pre-impregnated aramid fiber clothes and the pre-impregnated carbon fiber clothes are stacked and glued in the same way as described above with reference to FIG. 2 and/or FIG. 3.

At 520, the process may place new release films on both sides of the stacked and glued fabric.

At 525, the process may place steel plate die on the outside of the release films to hold the stacked and glued fabric in place to obtain the semi-finished product to be pressed.

At 530, the process may rapidly (e.g., in less than 10 minutes or in less than 5 minutes) increase the temperature of the press machine to a first temperature while the semi-finished product is placed in the press machine. This may allow the resin to fully dissolve and penetrate into the fabric. In some embodiments, the first temperature may be in the range of 100-200 degrees Celsius.

At 535, the process may slowly (e.g., in more than 30 minutes or in more than 45 minutes) and synchronously increase the pressure in the press machine to a pressure level to extrude the semi-finished product and maintain the condition (i.e., the pressure level and the first temperature) for a first time period. In some embodiments, the pressure level may be in the range of 700-1200 Kg. In some embodiments, the first time period may be in the range of 4-8 hours.

At 540, the process may reduce the temperature in the press machine to a second temperature within a second time period for cold pressing, then maintain the condition (i.e., the pressure and the second temperature) for a third time period to obtain the composite sheet. In some embodiments, the second temperature may be the room temperature. In some embodiments, the second time period may be a few minutes. In some embodiments, the second time period may be in the range of 3-15 minutes. The sudden cooling of the temperature makes the surface of the sheet cool quickly, while the pressure is applied to make the surface dense and flat. In some embodiments, third time period may be in the range of 1-3 hours.

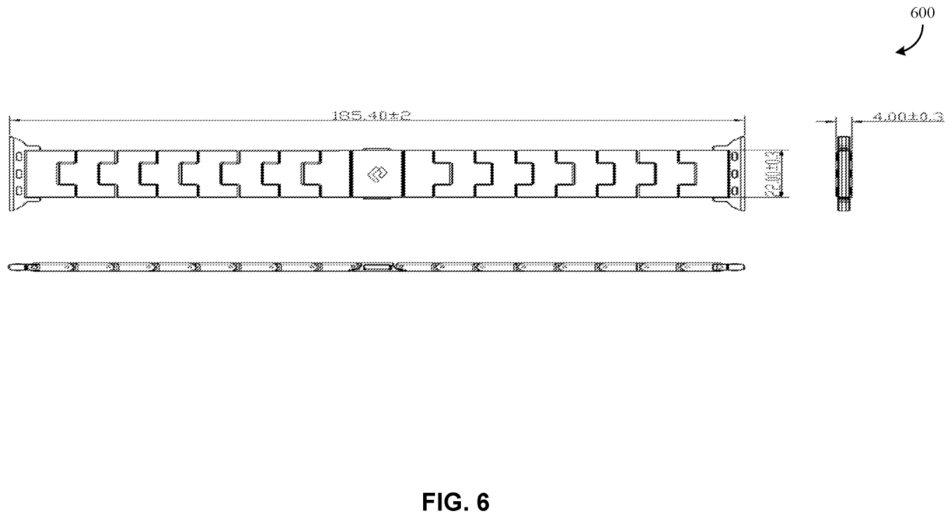

FIG. 6 illustrates an implementation example of the composite sheet according to some embodiments of the present disclosure. In this example, the composite sheet is used to make watch strap sections, which may be joined by lugs to form a watch strap. Different views of the watch strap 600 made from a composite sheet are shown in FIG. 6. In this example, the required thickness of the composite sheet may be 4 mm±0.53 mm; and high tensile strength may be required. The composite sheet can also be used in other products such as suitcase, handbag, eyeglass frame, and various wearable devices.

In some embodiments, an aramid fiber cloth may be placed on only one side of the watch strap sections as the outer fiber reinforcement layer. The aramid fiber cloth may be a single layer of bi-directional woven fabric with a thickness in the range of 0.2-0.3 mm. The aramid fiber cloth is used for decoration and to improve the surface toughness of the product.

In some embodiments, the intermediate structural support layers of the watch strap 600 may be unidirectional carbon fiber cloth in plural form (e.g., multiples of 4) with a thickness range of 0.15-0.25 mm. The angular difference (i.e., the difference of the first weaving directions) between adjacent layers may be 45°, with each 4 layers in a group (0°, 45°, 90°, 135°), repeated in 4 groups of 16 layers according to the requirements of the thickness of the product.

In some embodiments, the composite sheet for making the watch strap 600 may be produced using the processes 400 and 500 described above with respect to FIGS. 4 and 5. After the composite sheet is produced, a thickness test of the sheet may be conducted to ensure the composite sheet meets the thickness requirement of 4 mm±0.5 mm. The composite sheet is then made into watch strap sections.

In some embodiments, the watch strap sections may be tested to ensure that the tension reaches 15 kgf, the static tension is 1 min, the tensile and torsional fatigue reaches a pulling force of 3 kg, the torsional force reaches 3 kg, a torsional force is applied for 1000 times, and bending fatigue test is conducted for 5000 times.

In some embodiments, better tensile resistance between the layers may be obtained by the 45 degree stacking method. The regular stacking pattern gives an aesthetically pleasing wavy pattern to the sides of the watch strap sections.

Another implementation example of the composite sheet is the anti-theft credit card case. The required sheet thickness for this purpose may be 5 mm±1 mm. The pattern and color may be different on two sides of the case. The requirements for wear resistance may be high. The product has a wide range of 30° oblique cutting needs on a first side, and it is required to ensure the beauty of the pattern on the machined surface after cutting.

In some embodiments, the first side of the composite sheet for anti-theft credit card case may use aramid fiber clothes as outer fiber reinforcement layers. The first layer of aramid fiber cloth may be a bi-directional woven fabric and the second layer of aramid fiber cloth may be a unidirectional woven fabric. The total thickness of the aramid fiber clothes may be in the range of 0.3-0.5 mm. A second side of the composite for anti-theft credit card case may use aramid glass fiber blends as outer fiber reinforcement layers. The first layer of aramid glass fiber blend may be a bi-directional woven fabric and the second layer of aramid glass fiber blend may be a unidirectional woven fabric. The total thickness of the aramid glass fiber blends may be in the range of 0.2-0.4 mm. The outer fiber reinforcement layers play the role of decoration, improving the surface toughness of the product, and enhancing wear resistance. In some embodiments, the first side may be predominantly dark in color; the second side may have a light color pattern.

In some embodiments, there are thin unidirectional carbon fiber clothes as intermediate structural support layers near the first side of the composite sheet for anti-theft credit card case. Each of the carbon fiber clothes may have the thickness in the range of 0.1-0.2 mm. The carbon fiber clothes may be stacked in 6 layers, with 0° between adjacent layers. By stacking the layers in the same direction (i.e., the first weaving directions of the layers being the same), the wavy structure at one level is no longer visible, making it easier to cut diagonally and ensuring the aesthetics of the pattern in this diagonal cut.

In some embodiments, there are thick unidirectional carbon fiber clothes as intermediate structural support layers near the second side of the composite sheet for anti-theft credit card case. Each of the carbon fiber clothes may have the thickness in the range of 0.2-0.3 mm. The carbon fiber clothes may be stacked in 10 layers, with an angle difference (i.e., the difference of the first weaving directions) of 60° between adjacent layers. It should be noted that there are one thin unidirectional carbon fiber cloth and one thick unidirectional carbon fiber cloth adjacent to each other, and this pair of adjacent thin unidirectional carbon fiber cloth and thick unidirectional carbon fiber cloth may need to be stacked in different directions (i.e., the first weaving directions of them being different from each other).

In some embodiments, the composite sheet for anti-theft credit card case may be produced using the processes 400 and 500 described above with respect to FIGS. 4 and 5. After the composite sheet is produced, a thickness test of the sheet may be conducted to ensure the composite sheet meets the thickness requirement of 5 mm±1 mm. The composite sheet may also need to have a clear color pattern and meet the relevant abrasion resistance test.

It is understood by those skilled in the art that, the composite sheet is not limited by the structure mentioned above, and may include more or less components than those as illustrated, or some components may be combined, or a different component may be utilized.

It is understood by those skilled in the art that, all or part of the steps for implementing the foregoing embodiments may be implemented by hardware, or may be implemented by a program which instructs related hardware. The program may be stored in a flash memory, in a conventional computer device, in a central processing module, in an adjustment module, etc.

The above descriptions are merely embodiments of the present disclosure, and the present disclosure is not limited thereto. All modifications, equivalent substitutions and improvements made without departing from the conception and principle of the present disclosure shall fall within the protection scope of the present disclosure.

Further embodiments also include various subsets of the above embodiments including embodiments as shown in FIGS. 1-6 combined or otherwise re-arranged in various other embodiments.

Although the detailed description contains many specifics, these should not be construed as limiting the scope of the disclosure but merely as illustrating different examples and aspects of the disclosure. It should be appreciated that the scope of the disclosure includes other embodiments not discussed in detail above.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

It will be understood that, although the terms “first,” “second,” etc. may be used herein to describe various elements or steps, these elements or steps should not be limited by these terms. These terms are only used to distinguish one element or step from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art to best utilize the disclosure and the various embodiments.

What is claimed is:

1. A composite sheet comprising:
one or more outer fiber reinforcement layers, wherein at least one surface of the composite sheet is a first outer fiber reinforcement layer of the one or more outer fiber reinforcement layers; and
one or more intermediate structural support layers, wherein the one or more intermediate structural support layers comprise at least one of a carbon fiber cloth layer and a carbon glass fiber blend layer, wherein a toughness of the one or more outer fiber reinforcement layers is higher than a toughness of the one or more intermediate structural support layers, wherein a color of the one or more outer fiber reinforcement layers is dyed or is different from a color of the one or more intermediate structural support layers.

2. The composite sheet according to claim 1, wherein another surface of the composite sheet is a second outer fiber reinforcement layer of the one or more outer fiber reinforcement layers.

3. The composite sheet according to claim 1, wherein the one or more outer fiber reinforcement layers comprise at least one of an aramid fiber cloth layer, an aramid carbon fiber blend layer, an aramid glass fiber blend layer, and a natural plant fiber layer.

4. The composite sheet according to claim 3, wherein a thickness of the aramid fiber cloth layer is 0.1-0.3 mm.

5. The composite sheet according to claim 1, wherein the toughness of the one or more outer fiber reinforcement layers is higher than two times of the toughness of the one or more intermediate structural support layer.

6. The composite sheet according to claim 1, wherein two adjacent layers are glued together by a thermoplastic resins coating or a thermosetting resins coating.

7. The composite sheet according to claim 1, wherein the first outer fiber reinforcement layer is a bi-directional woven outer fiber reinforcement layer.

8. The composite sheet according to claim 7, wherein a second outer fiber reinforcement layer of the one or more outer fiber reinforcement layers is a unidirectional woven outer fiber reinforcement layer.

9. The composite sheet according to claim 1, wherein the one or more intermediate structural support layers are unidirectional woven intermediate structural support layers.

10. The composite sheet according to claim 1, wherein, except for the first outer fiber reinforcement layer, all other layers are stacked in such a way that first weaving directions of each pair of adjacent layers differ by no less than 0° and no greater than 180°.

11. The composite sheet according to claim 10, wherein the first weaving directions of each pair of adjacent layers differ by 45°.

12. The composite sheet according to claim 1, wherein an isotropic stacking is used on a set of layers that are to be cut.

13. The composite sheet according to claim 1, wherein bi-directional woven fabrics are used on a set of layers that are to be cut.

14. The composite sheet according to claim 1, wherein a process of making the composite sheet comprises:
obtaining pre-impregnated aramid fiber clothes and pre-impregnated carbon fiber clothes;
stacking and gluing the pre-impregnated aramid fiber clothes and the pre-impregnated carbon fiber clothes to obtain a semi-finished product;
rapidly increasing a temperature of a press machine to a first temperature while the semi-finished product is placed in the press machine;
slowly and synchronously increasing a pressure of the press machine to a pressure level to extrude the semi-finished product;
maintaining the pressure level and the first temperature for a first time period;
reducing the temperature of the press machine to a second temperature within a second time period; and
maintaining the pressure level and the second temperature for a third time period.

15. The composite sheet according to claim 14, wherein the first temperature is in the range of 100-200 degrees Celsius, wherein the second temperature is room temperature.

16. The composite sheet according to claim 14, wherein the pressure level is in the range of 700-1200 Kg.

17. The composite sheet according to claim 14, wherein the first time period is in the range of 4-8 hours, wherein the second time period is in the range of 3-15 minutes, wherein the third time period is in the range of 1-3 hours.

18. A section of a watch strap comprising:
one or more outer fiber reinforcement layers, wherein at least one surface of the section of the watch strap is a first outer fiber reinforcement layer of the one or more outer fiber reinforcement layers; and
one or more intermediate structural support layers, wherein the one or more intermediate structural support layers comprise at least one of a carbon fiber cloth layer and a carbon glass fiber blend layer, wherein a toughness of the one or more outer fiber reinforcement layers is higher than a toughness of the one or more intermediate structural support layers, wherein a color of the one or more outer fiber reinforcement layers is dyed or is different from a color of the one or more intermediate structural support layers.

19. The section of the watch strap according to claim 18, wherein the first outer fiber reinforcement layer is an aramid fiber cloth layer, wherein the aramid fiber cloth layer is a bi-directional woven fabric.

20. The section of the watch strap according to claim 18, wherein the one or more intermediate structural support layers are unidirectional woven intermediate structural support layers.
